(19) United States
(12) Patent Application Publication
(10) Pub. No.: US 2003/0177015 A1
(43) Pub. Date: Sep. 18, 2003

(54) Method for optimizing purchase process in an enterprise group

(76) Inventor: Hung Liang Chiu, Taipei (TW)

Correspondence Address: JACOBSON HOLMAN PLLC, 400 SEVENTH STREET N.W., SUITE 600, WASHINGTON, DC, 20004, US

(21) Appl. No.: 10/098,565

(22) Filed: Mar. 18, 2002

(51) Int. Cl. G06F 17/60

(52) U.S. Cl. 705/1

(57) ABSTRACT

A purchasing information system applicable to an enterprise group in which the purchasing information is suitably integrated and used to optimize further purchasing. The system and method of the invention utilizes a database integrating price information of materials and informing purchasing personnel or publishing on a local network of the enterprise to help efficient purchases. When a purchase is prepared in the enterprise, the information is transferred to a database in a specific format. The database integrates the purchasing information into a report, in which any information concerning the same material is reviewed. Then, the integrated information is published through a network and emailed to related people of the enterprise.

### BACKGROUND OF THE INVENTION

1. Field of the Invention

The invention generally relates to an information system, and particularly relates to a purchase information system and method applicable to an enterprise group for which the purchase information is suitably integrated and used to optimize further purchasing.

2. Related Art

With recent technological developments and growth of enterprises, the business of an enterprise has become more and more complicated. Conventional material management cannot fulfill the requirements of modem enterprises. So, an integrated, broad-view concept of supply chain management (SCM) has been suggested. In SCM operations, the most important aspect is material flow, which includes material purchasing, delivery and manufacturing for an enterprise.

The current trend of business-to-business electronic trade emphasizes trading via networks. However, for a manufacturer, the biggest concern is what to purchase, when to purchase and how to process the materials for production. It often happens that different sections in a large enterprise group purchase the same material at different prices. As shown in FIG. 1, in a conventional enterprise group, a plurality of suppliers 60a˜60n provide materials to many branches 10a to 10n and factories 20a to 20n. Any supplier 60a˜60n may supply any branch 10a˜10n and any factory 20a˜20n. For example, a supplier 60c supplies the branch 10n and the factory 20a. It is possible that different prices are quoted from the supplier to the purchaser for a same material because the purchases are operated separately at each purchaser, and the purchasing information is not open and shared. The different and higher price causes waste to the enterprise.

Therefore, it is necessary to have a system and method that shares purchasing information in an enterprise group and optimizes purchasing operations.

### SUMMARY OF THE INVENTION

The object of the invention is to provide a purchasing information method applicable to an enterprise group in which the purchase information is suitably integrated and used to optimize further purchasing. The method of the invention utilizes database integrating price information of materials and informs purchase personnel or publishes on an intranet of the enterprise to help efficient purchasing. The database provides information of past purchases that prevents further purchases at a higher price, so that the cost of purchasing can be decreased and the profit for the enterprise can be increased.

The process of the invention includes the following steps. When a purchase is prepared in the enterprise, the information is transferred to a database in a specific format. The database integrates the purchase information into a report, in which any information concerning the same material is reviewed. Then, the integrated information is published through a network and emailed to related people of the enterprise.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a schematic view illustrating the conventional purchasing activities in an enterprise group;

FIG. 2 is a systematic block diagram of a purchasing information system of the invention;

FIG. 3 is a schematic view showing the data transfer method in a purchasing information method of the invention; and

FIGS. 4a and 4b are flowcharts of a purchasing information method of the invention that optimizes the purchasing process in an enterprise group.

### DETAILED DESCRIPTION OF THE INVENTION

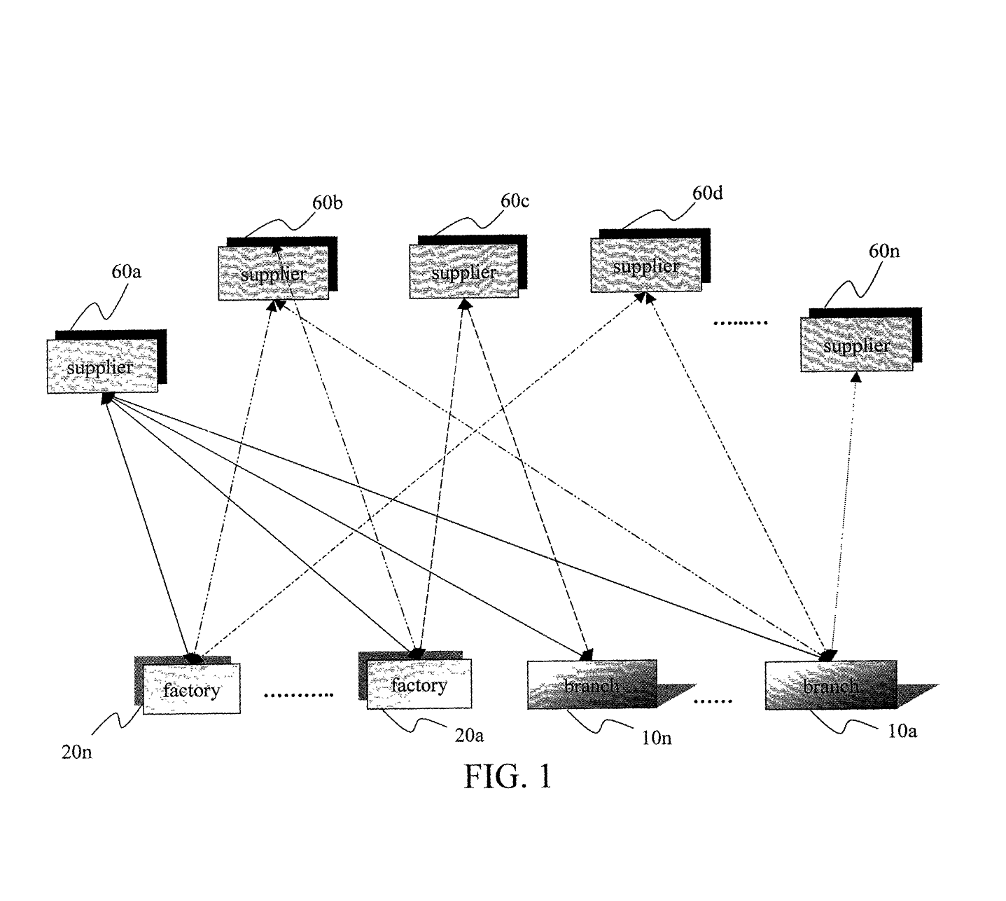

The invention provides an information system and method for optimizing purchasing in an enterprise group. The object of the information method is to utilize and manage enterprise resources, reengineer the process flow in order to improve efficiency, and reducing cost in the purchasing process. This is also a solution for supply chain management (SCM) and enterprise resource planning (ERP), which have recently become important issues of enterprise management. The information method of the invention can be applied in an ERP server of an enterprise in which purchasing information e and material sources are instantly transferred and published so that material purchases in the whole enterprise group can be integrated and efficiently managed. A preferred embodiment of the invention is illustrated in FIGS. 1 to 4b, and is described below.

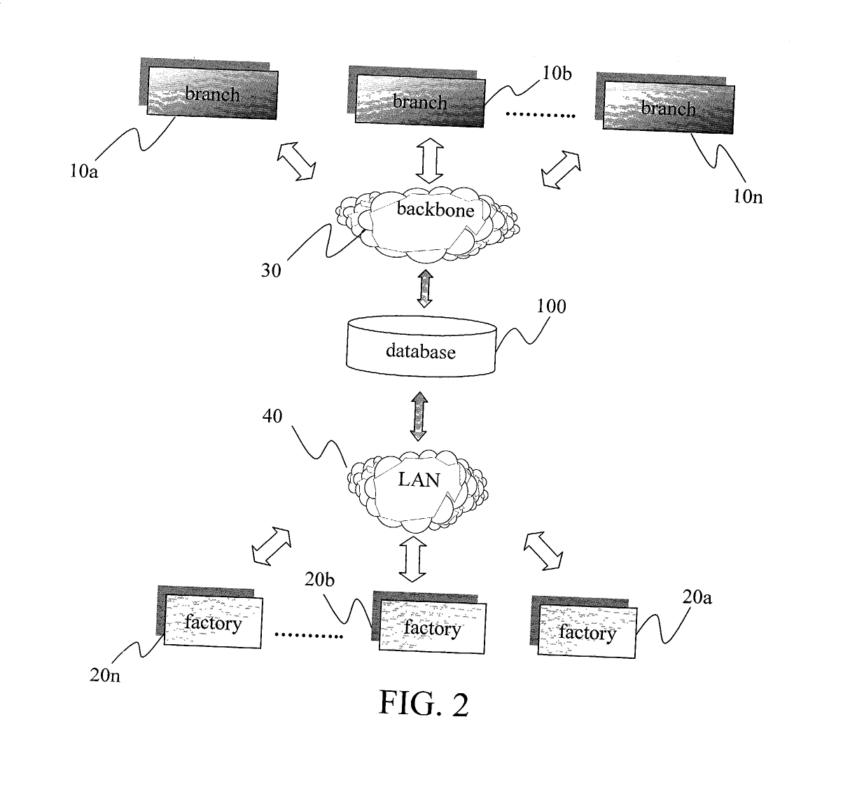

FIG. 2 is a systematic block diagram of a purchasing information system according to the invention. The system can be applied in an enterprise resource-planning server of an enterprise. The enterprise includes one or more branches 10a to 10n and one or more factories 20a to 20n. The branches 10a to 10n are peripheral business groups of the enterprise that communicate through a network backbone 30 and are connected to a database 100. The backbone 30 can be any network structure that supports communication and information transfer. The factories 20a to 20n are interior workgroups of the enterprise that communicate through a local area network (LAN) 40 and are connected to the database 100. The local area network 40 can be an Ethernet network.

Purchase orders from the branches 10a to 10n or the factories 20a to 20n are transferred to the database 100 where the prices of materials and the suppliers are integrated and reported. Therefore, different branches 10a to 10n or factories 20a to 20n will not purchase the same material at different or higher prices, or the same material from different suppliers will not cost different. The prices of purchases are provided through a network or emails to the purchasing personnel or supervisors. The automatic information process is controlled by an executive information system. By the monitoring process, the price of a purchase can be controlled and minimized, and the maximum profit for the enterprise can be obtained.

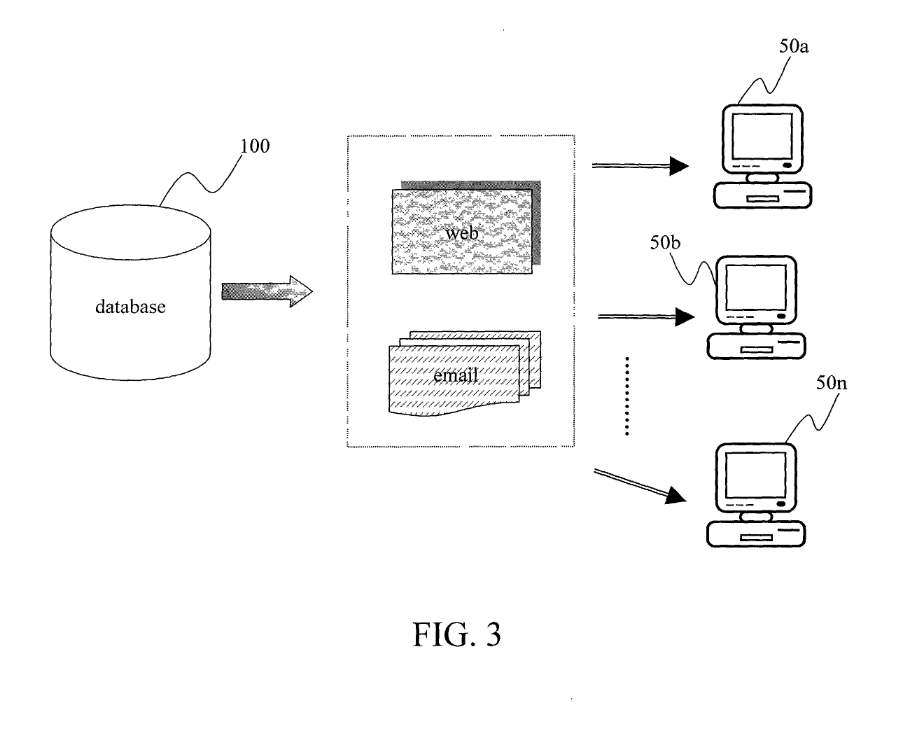

FIG. 3 shows the data transfer method in a purchasing information method of the invention. When purchasing information is transferred to the database 100, it is transformed into a suitable format for easy reference for related persons. For example, exchange rates between different country currencies are transformed. Additional delivery charge among suppliers, branches 10a˜10n and factories 20a˜20n are also considered. Then, suggestions on preferred suppliers 60a to 60n and prices are provided via web pages and emails to a plurality of users 50a to 50n. The users 50a to 50n are related executives or purchasing personnel that can obtain the information through security authorities of the information system.

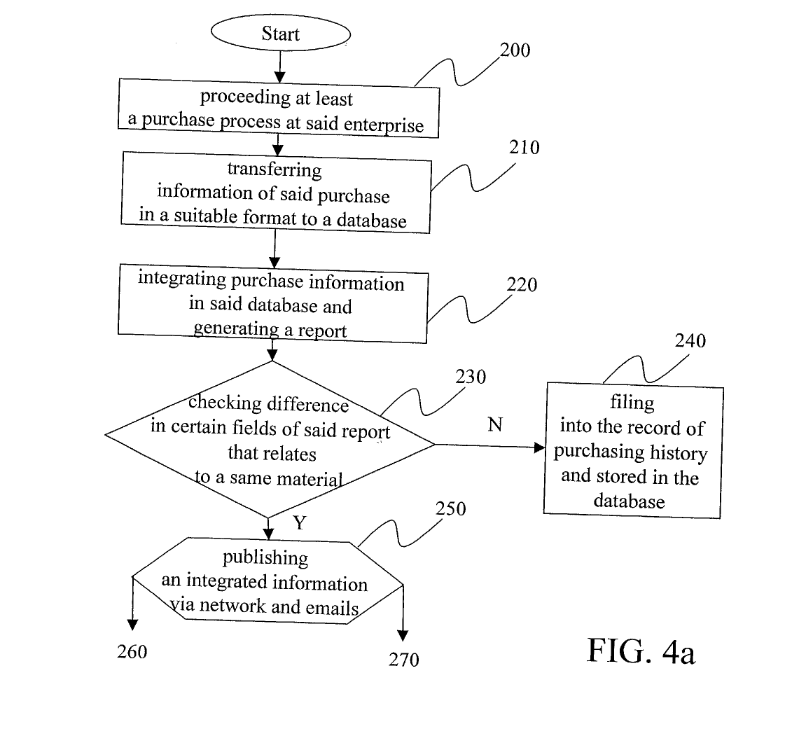

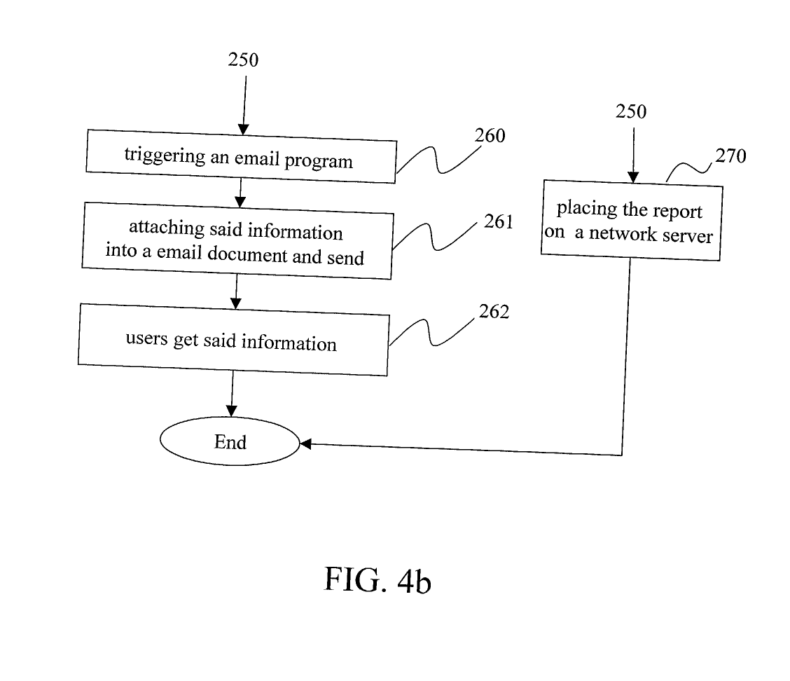

FIGS. 4a and 4b are flowcharts showing the process of providing purchasing information for optimizing purchasing in an enterprise group according to the invention. In step 200, a purchase is prepared in the enterprise for which at least one material is selected and one bill of material for purchase is listed. The bill of material is transferred to a database 100 in a specific format (step 210). The specific format is a database structure including name of the branch 10a′10n or factory 20a′20n; name, part number and price of the material in the enterprise, name of the supplier and part number of the material at the supplier 60a˜60n. The database 100 integrates the purchasing information and generates a report (step 220) at a predetermined time set by the users 50a˜50n. The contents of the report are reviewed so that any difference occurring for the same material at specific fields in the report are checked (step 230). When the values in specific fields exceed certain criteria predetermined in the database 100, abnormality is indicated. Otherwise, if the values conform to the criteria, the purchasing information is then filed into the record of purchasing history (step 240) and stored in the database 100. When an abnormality occurs, the integrated information is published (step 250) through emails and a network as in steps 260 and 270. In step 270, the report is placed on a network server and is reachable by users 50a˜50n through a web page browser navigating at a designated address. The integrated information is also transformed by an email program (step 260), attached or merged into an email document and sent (step 261) to the users 50a˜50n. The process is then finished.

The aforesaid database 100 can be a server running with structured query language (SQL). The email publication is controlled and monitored by an executive information system that inquires and selects interior and exterior information, monitors the difference and provides warning messages to related executives.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method, applicable in a purchase information system, for optimizing purchase process in an enterprise group through material inquiry planning in an enterprise resource planning sever and providing information through network to suppliers, comprising steps of:
proceeding at least a purchase process at said enterprise;
transferring information of said purchase in a suitable format to a database;
integrating purchase information in said database and generating a report;
checking any difference in certain fields of said report that relates to a same material; and
publishing an integrated information in said enterprise via network and emails.

2. The method of claim 1, wherein said enterprise comprises at least a branch and a factory.

3. The method of claim 2, wherein said branch connects to said database through a network backbone.

4. The method of claim 3, wherein said network backbone is a network structure supporting data communication and information transfer.

5. The method of claim 2, wherein said factory connects to said database through a local area network, including an Ethernet.

6. The method of claim 1, wherein said suitable format of information is a database structure comprising a name of said branch and factory, a part number, a price of material in said enterprise, a name of supplier, and a part number of material at said supplier.

7. The method of claim 1, wherein said database is a SQL server.

8. The method of claim 1, wherein said report is generated at a predetermined time settled by users in said enterprise.

9. The method of claim 1, wherein said step of checking difference in certain fields of said report is to review values in said fields that if said values exceed certain criteria predetermined in said database, then abnormality is judged.

10. The method of claim 1, wherein said integrated information is published by a web sever through web pages that users can reach through browsers.

11. A method for optimizing purchase process in an enterprise group according to claim 1 wherein said step of publishing an integrated information via emails is controlled by an executive information system and comprises steps of:
triggering an email program;
attaching said information into a email document and send; and
users get said information.

12. The method of claim 11, wherein said executive information system inquires and selects interior and exterior information, monitors difference and provides warning messages to related executives.
